(19) United States
(12) Patent Application Publication
(10) Pub. No.: US 2023/0331574 A1
(43) Pub. Date: Oct. 19, 2023

(54) Calcination Process

(71) Applicant: Origen Power Ltd, Walsall (GB)

(72) Inventors: Barrie Jenkins, Walsall (GB); Christine Bertrand, Walsall (GB)

(21) Appl. No.: 18/299,770

(22) Filed: Apr. 13, 2023

(30) Foreign Application Priority Data
Apr. 14, 2022 (GB) 2205580.0

(51) Int. Cl. C01F 11/06; C01F 11/16

(52) U.S. Cl. CPC C01F 11/06; C01F 11/16

(57) ABSTRACT

There is provided herein a process for producing metal oxide in a flash calciner, the process comprising:
a. pre-heating a metal carbonate particulate stream, prior to the particulate stream being fed into the flash calciner; and,
b. calcining the particulate stream in a flash calciner to produce a raw stream comprising metal oxide and a flue gas comprising CO₂,
   wherein at least a portion of the flue gas comprising CO₂ produced in step (b) is used to pre-heat the metal carbonate particulate in step (a).

### BACKGROUND TO THE INVENTION

Global atmospheric CO₂ levels in 2019 were 410 ppm, higher than at any point in at least the past 800,000 years. Today, global anthropogenic CO₂ emissions exceed 35 billion tonnes per year. Over the last decade growth in atmospheric CO₂ levels has averaged 2.3 ppm per year and shows no sign of slowing. The Intergovernmental Panel on Climate Change (IPCC) have reached a troubling conclusion: to avoid catastrophic climate change the increase in average global temperature above pre-industrial levels must be kept below 1.5° C. There is growing scientific consensus that humans have already exceeded safe levels of CO₂ in the atmosphere.

Every scenario to avoid a 1.5° C. rise involves removing CO₂ from the atmosphere. The low-end IPCC estimate requires the removal of 100 billion tonnes of CO₂ per year by 2100, three times more than current emissions.

Burning fuel generates CO₂. However, carbon capture and storage technologies allow for this CO₂ to be prevented from entering the atmosphere. Carbon capture and storage technologies include chemical media which can be used to trap CO₂. This media can then be subsequently stripped of CO₂ through the application of heat, resulting in a concentrated CO₂ stream that can be dried, purified and compressed ready for sequestration. The chemical media is simultaneously regenerated for re-use. As carbon capture and storage technologies prevent CO₂ emissions from entering the atmosphere, they are known as mitigation technologies.

CO₂ can also be removed using Negative Emissions Technologies (NETs). NETs take CO₂ that is already in the atmosphere out of the atmosphere. However, NETs have problems with scalability and cost.

Current solutions fail to address these problems because they take a thermodynamically flawed approach—i.e., CO₂ removal directly from air by mechanical means. CO₂ is very dilute (approx. 0.04%) so these processes must move huge quantities of air to capture CO₂ resulting in high operating expenses from energy use, large plant footprints and consequently high capital expenditure. Scale-up is completely impractical and therefore not economically viable.

The inventors have found a way to combine carbon capture and storage with a NET by way of a calcium looping system. This calcium looping system exploits the reversible reaction between calcium oxide (CaO) and CO₂, which can be split into two steps: (1) calcination, and (2) re-carbonation.

In step (1) CaCO₃ thermally decomposes to CaO and CO₂. This calcination step is carried out in a way that high-purity CO₂ ready for sequestration can be produced. This also includes the CO₂ generated from the combustion of fuel gas, which is required to thermally decompose the CaCO₃.

In step (2), CaO reacts with CO₂ (either from the air or flue gas from industrial processes) to produce CaCO₃.

### STATEMENT OF THE INVENTION

According to one aspect of the present invention, a process for producing metal oxide in a flash calciner, the process comprising:
a. pre-heating a metal carbonate particulate stream, prior to the particulate stream being fed into the flash calciner; and,
b. calcining the particulate stream in a flash calciner to produce a raw stream comprising metal oxide and a flue gas comprising CO₂,
   wherein at least a portion of the flue gas comprising CO₂ produced in step (b) is used to pre-heat the metal carbonate particulate in step (a).

According to another aspect of the present invention, a calcination plant comprising:
a flash calciner arranged to calcine a metal carbonate particulate stream; and,
a cyclonic heat exchanger system coupled to the flash calciner and configured to feed the metal carbonate particulate stream into the flash calciner;
   wherein a flue outlet of the flash calciner is coupled to an inlet of the cyclonic heat exchanger system such that in use, at least a portion of the flue gas produced by calcination of the metal carbonate particulate stream is used to pre-heat the metal carbonate particulate in the cyclonic heat exchanger system.

According to yet another aspect of the present invention, a method for calcining metal carbonate feedstock within a flash calciner to produce a metal oxide and CO₂ flue gas, comprises feeding a portion of recirculated CO₂ flue gas back into the flash calciner via a fluid path which includes a preheater furnace which heats the CO₂ flue gas to a temperature of at least 650° C. Preferably, the CO₂ flue gas is recirculated at above atmospheric pressure within the fluid path using a fan. Preferably, the fan is arranged in a forced draft configuration. Preferably, the CO₂ flue gas is heated within the preheater furnace by combustion of a fuel/oxygen mixture.

According to a further aspect of the present invention, a method for calcining a metal carbonate feedstock within a flash calciner to produce a metal oxide and CO₂ flue gas, comprises recirculating a least a portion of the CO₂ flue gas at a pressure above atmospheric pressure within a closed loop fluid path which includes the flash calciner. Preferably, the CO₂ flue gas is recirculated at above atmospheric pressure within the fluid path using a fan in a forced draft configuration. Preferably, the recirculated CO₂ flue gas is used to carry a fluidised stream of metal carbonate feedstock through one or more counter flow cyclonic heating stages, wherein the metal carbonate feedstock is thereby heated by the CO₂ flue gas prior to being fed into the flash calciner.

Advantageously, the present invention relates to a system wherein the flue gas stream is part of a closed loop (i.e., a flue gas loop). This means that the flue gas stream is repeatedly recycled. A benefit of this closed system is that fuel gas is burnt in the flue gas, rather than in air as is the case in conventional lime kiln processes. The flue gas from conventional lime kiln processes typically comprises a large proportion of nitrogen, making separation from the flue gases of conventional calcination both costly and energy intensive. Therefore, the process of the invention is advantageous as nitrogen is not introduced.

Advantageously, the flue gas loop is a pressurised (i.e., above atmospheric pressure) using a fan in a forced draft configuration. The forced draft configuration of the system ensures that the system is always at an over pressure to isolate the system from the surrounding atmosphere, even if there are openings to the atmosphere within the system. This means that contaminants cannot enter the system. A further benefit of the forced draft configuration is that the flue gas loop of the system controls the internal pressure.

The (recycled) flue gas stream advantageously provides the required gas flow volumes for the correct passage of solid (particulate) materials through the system. In other words, the forced draft system means that the flue gas stream acts as a transport mechanism for the particulate materials used in the system.

The present invention also advantageously allows for an energy efficient process wherein the heat energy generated during the calcination process is captured and used in the system to heat the metal carbonate prior to the calcination step. This means that the metal carbonate subsequently enters the flash calciner when it is at an elevated temperature.

The present invention also advantageously comprises a step wherein the flue gas is reheated before it re-enters the flash calciner and acts as a diluent. This step helps to ensure that a forward calcination reaction is taking place over a re-carbonation reaction. A further advantage of this step is that allows for auto-ignition of a fuel/oxygen mix to occur within the flash calciner—typically at temperatures of around 650° C. and above—to maintain the calcination reaction.

A further advantage of the present invention is that the system is configured in such a way that all the CO₂ generated from both the combustion of the fuel gas and the calcination of the metal carbonate is concentrated as a high purity CO₂ in the resulting flue gases. Said high purity CO₂ can readily be sequestered/captured.

### BRIEF DESCRIPTION OF THE DRAWINGS

Examples of the present invention will now be described in detail with reference to the accompanying drawings, in which:

FIG. 1 is a simplified schematic of a flue gas loop according to the present invention;

FIG. 2 is a schematic of a flue gas loop according to the present invention;

FIG. 3 is a schematic of a system according to the present invention;

FIG. 4 is a diagram of a cyclone; and,

FIG. 5 is a schematic of a milling system.

### DETAILED DESCRIPTION

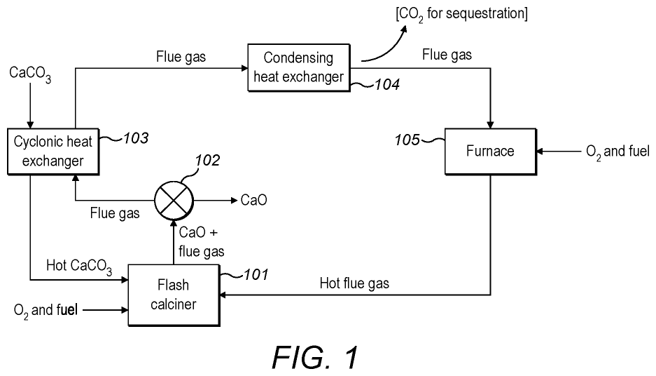

FIG. 1 shows a simplified schematic of a flash calciner plant for the production of lime (CaO) from limestone (CaCO₃). The plant comprises a flash calciner 101, a separator 102, a cyclonic heat exchanger 103, a condensing heat exchanger 104, and a pre-heater furnace 105. These plant components are couped together to form a fluid pathway for flue gas from the flash calciner 101 to be recirculated within the system, as will be described in more detail below.

The flash calciner 101 has an inlet for receiving a feed material via the cyclonic heat exchanger 103, an inlet for receiving an admixture of fuel gas and oxygen, and an inlet for receiving a diluent. The flash calciner 101 also has an outlet for the products of a calcination reaction taking place in the flash calciner 101.

The separator 102 comprises a device for separating solid particles from a gas stream and is coupled to the outlet of the flash calciner 101. An outlet of the separator 102 is coupled to direct flue gas to the cyclonic heat exchanger 103 and another outlet is coupled to direct CaO product to a product silo for storage. The separator 102 may comprise a cyclone separator, preferably of a Stairmand design.

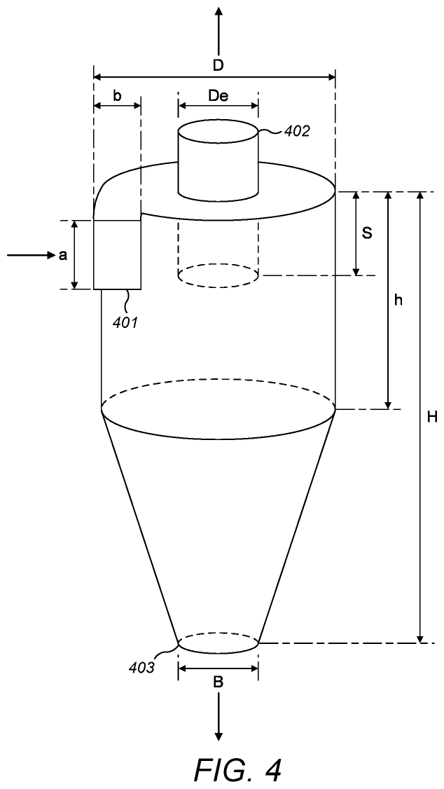

The cyclonic heat exchanger 103 is used to pre-heat the feedstock material using a counter flow of hot flue gas from the flash calciner 101. As described in more detail below with reference to FIG. 4, the cyclonic heat exchanger 103 has an inlet for receiving the feed material and also hot flue gas from the flash calciner 101 (via the separator 102), and an outlet that is coupled to the flash calciner 101 to deliver pre-heated feedstock for calcination. The cyclonic heat exchanger 103 has a further outlet that is coupled to an inlet valve of the condensing heat exchanger 104, where waste heat from the flue gas can be recovered to raise steam for use in an oxygen generation plant (not shown).

At condensing heat exchanger 104, some CO₂ within the flue gas is recovered for storage whilst the remainder of the now cool flue gas is coupled to the pre-heater furnace 105 where it is reheated by combustion of a fuel and O₂ mixture before being fed to an inlet of the flash calciner 101 via an outlet valve of the furnace 105.

With reference to FIG. 1, the process of the present invention therefore comprises:
i. Combustion of a fuel gas with oxygen in a flash calciner 101 in order to produce heat and a flue gas comprising CO₂.
ii. Calcination of CaCO₃ in the flash calciner 101 in order to generate CaO and more flue gas comprising CO₂. The CaCO₃ enters the flash calciner 101 as a particulate stream. Prior to entering the flash calciner 101, the CaCO₃ particulate stream moves through a series of cyclonic heat exchangers 103.
iii. An exhaust gas comprising CaO and CO₂ exit the flash calciner 101, and then the CaO is separated from the flue gas stream at a separator 102.
iv. A portion of the flue gas stream enters the series of cyclonic heat exchangers 103 and moves through the cyclonic heat exchangers 103 in a counter current manner to the CaCO₃ particulate stream.
v. A portion of the flue gas stream exits the series of cyclonic heat exchangers 103 and enter a condensing heat exchanger 104.
vi. A portion of the flue gas stream can then be heated in a furnace 105 and recycled back into the flash calciner 101.

Fuel, preferably in gaseous form, such as natural gas, is used to provide the heat to power the flash calciner 101. The fuel may be turned gaseous by, for example, heating or by dispersing a solid fuel in a flow of fine particles. The flash calciner 101 breaks down calcitic minerals (calcium carbonate bearing rock—typically limestone or chalk) into lime (CaO) and carbon dioxide (CO₂). The plant is configured in such a way that all the carbon dioxide CO₂ generated from both the combustion of the natural gas and the calcination of calcite is produced as a high purity CO₂ flue gas.

The oxygen required for the combustion processes may be supplied from an on-site oxygen generation plant, which may be one of a PSA/VSA (pressure/vacuum swing adsorption) plant, an ASU (air separation unit) or a cryogenic separation plant. The air compressor for this unit is driven by a steam turbine, this steam being generated in a waste heat recovery system which includes the condensing heat exchanger 104 used to cool the flue gas after the cyclonic heat exchangers 103.

Those skilled in the art will understand a cyclonic heat exchanger 103 to be a plurality of heat exchange stages formed by cyclone separators arranged one above the other, which comprise an inlet for the delivery of raw material to the heat exchanger, an outlet for delivering the heated raw material from the heat exchanger to the flash calciner, another inlet for delivering hot gas from the flash calciner to the heat exchanger, and another outlet for delivering the cooled gas from the heat exchanger.

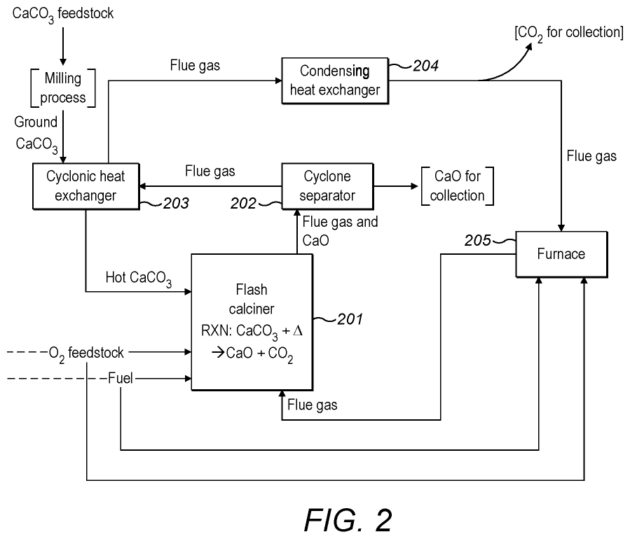

FIG. 2 shows a more detailed schematic of a flash calciner plant for the production of lime. The flash calciner 201, cyclone separator 202, cyclonic heat exchanger 203, condensing heat exchanger 204 and furnace 205 generally correspond to the flash calciner 101, separator 102, cyclonic heat exchanger 103, condensing heat exchanger 104 and furnace 105 of FIG. 1 and are coupled in a similar manner. However, the schematic of FIG. 2 additionally illustrates CaCO₃, O₂ and fuel feedstocks that feed into the cyclonic heat exchanger 203 and flash calciner 201 and furnace 205. As shown in FIG. 2, the same O₂ and fuel feedstocks may be used to supply both the flash calciner 201 and the furnace 205.

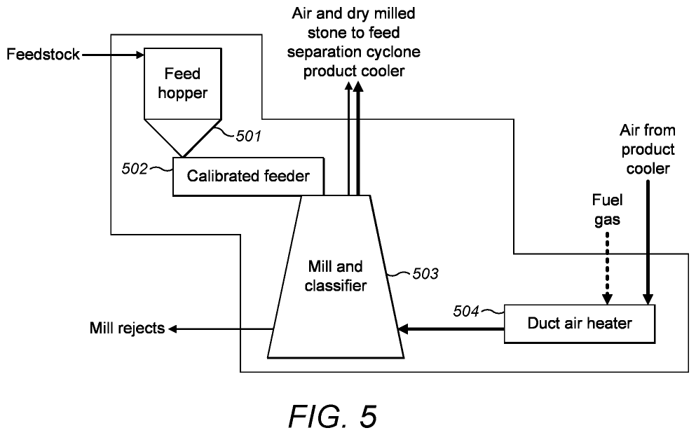

FIG. 2 also illustrates that a milling process (e.g., a milling system 312) may be used to mill the CaCO₃ feedstock into ground CaCO₃ before it is fed into the cyclonic heat exchanger 203 (e.g., using the milling system of FIG. 5, which will be described in more detail below). The milling system 312 comprises a feed hopper 313 coupled to a non-return valve 314 which feeds material into the system and prevents the escape of flue gases to atmosphere.

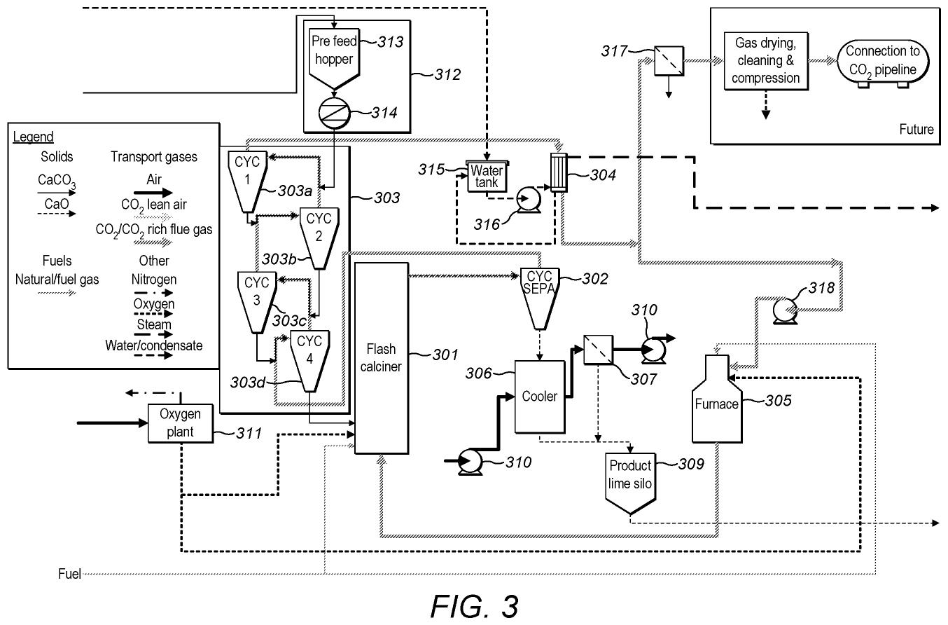

FIG. 3 shows an even more detailed schematic of a flash calciner plant for the production of lime. The flash calciner 301, cyclone separator 302, series of cyclonic heat exchangers 303, condensing heat exchanger 304 and furnace 305 again generally correspond to the flash calciner 101, separator 102, cyclonic heat exchanger 103, condensing heat exchanger 104 and furnace 105 of FIG. 1 and are coupled in a similar manner.

Rather than a single cyclonic heat exchanger, the plant in FIG. 3 uses a series of four cyclonic heat exchangers 303. However, an alternative number of cyclonic heat exchangers could be used. For example, 2, 3, 5 or 6 cyclonic heat exchangers may be used in series in the present invention.

In the illustrated embodiment (i.e., when four cyclonic heat exchangers are used) the particulate comprising CaCO₃ is preheated (and it is postulated to be at least partially calcined) prior to its introduction to the flash calciner 301. These cyclones use the hot gas from the flash calciner 301 (i.e., the flue gas) in a counter flow system to exchange heat. The counter flow system of the cyclonic heat exchangers means that the CaCO₃ is effectively carried through the cyclonic heat exchangers by the flue gas.

After passing through a first stage cyclone 303, the separated CaCO₃ feed from the bottom of the first stage cyclone 303a is then dropped through a sealing valve system into the hot gas stream up-pipe that feeds into a second stage cyclone 303b. This up-pipe stream into the second stage cyclone 303b is at a higher pressure than the pressure in the pipe from the bottom of the first stage cyclone 303a feed, and hence the sealing valve ensures that if there is any cross leakage, it will result in a small amount of the CO₂/H₂O stream going into the air, rather than N₂ getting into the CO₂/H₂O stream.

This gas and material flow arrangement is repeated for two lower cyclones 303c-d, down to the flash calciner 301. For example, the particulate comprising CaCO₃ enters the first stage cyclone 303a first, followed by the second stage cyclone 303b, followed by the third stage cyclone 303c, followed by a fourth stage cyclone 303d and then enters the flash calciner 301.

The design of the cyclones 303a-d is governed by the required separation efficiency and the allowable pressure drop for each stage. The hotter cyclones are internally lined and insulated with refractory material. The skilled person will appreciate that the temperature of the flue gas stream decreases as it moves from the fourth stage cyclone 303d to the first stage cyclone 303a.

In a preferred embodiment, the cyclones 303a-d that make up the cyclonic heat exchangers are short-bodied cyclones. Short-bodied cyclones advantageously reduce the height requirements of the tower that the cyclones may be housed in. Advantageously the short-bodied format has been found to be suitable as the function of the cyclones 303a-d is primarily to exchange heat rather than efficiently separate material.

In a preferred embodiment, the mass ratio of the solids (i.e., the particulate) to the flue gas in the flash calciner is approximately 1 kg solid to 1 kg flue gases i.e., a 1:1 ratio by mass.

As described above, the oxygen required for the combustion processes may be supplied from an on-site oxygen generation plant such as oxygen plant 311. An admixture of fuel combined with oxygen generated from the oxygen plant 311 is fed into each of the flash calciner 301 and the furnace 305.

In the flash calciner 301, this admixture is burnt in order to provide thermal energy necessary for the calcination process, whereas the furnace 305 is used to re-heat the recycled flue gas (preferably to a temperature of from 500° C. to 1200° C., preferably from at least 650° C. to 1200° C., more preferably 900° C. to 1100° C.) before it re-enters the flash calciner 301. One of the purposes of raising the temperature of the flue gas at this stage is to support auto-ignition of the fuel/oxygen mix within the flash calciner 301 to sustain the calcination reaction. The precise ignition point for the fuel will depend on the fuel type, but typically a temperature of at least around 650° C. is thought to be sufficient for the hydrocarbon fuel types discussed below.

Advantageously, the oxygen used in the process of the present invention does not need to be pure O₂. This provides economic benefits over the prior art as well as subsequently reducing O₂ contaminants in the flue gas stream. This also reduces the purification steps required to be carried out on the CO₂ sequestered from the system. Where the fuel comprises a hydrocarbon, the process that takes place in the flash calciner and/or the furnace can be expressed as:

CₙHₓ+O₂→CO₂+H₂O+Δ

Hydrocarbon fuels that may be used use in the present invention include, but are not limited to, natural gas, coal bed methane, blast furnace gas, coke oven gas, coal gas, lean reformer gas, syngas (such as lurgi crude syngas), propane, light distillate, kerosene, gas oil, medium fuel oil, heaving fuel oil, anthracite, bituminous coal, lignite, wood, charcoal, industrial coke, petroleum coke. As mentioned above, these fuels will typically ignite at temperatures of around 650° C. and above.

In conventional lime kilns, nitrogen is used to attemperate the temperature in the flash calciner. However, using nitrogen has the disadvantage that it then has to be subsequently separated from the flue gas if pure carbon dioxide is required. This separation process is costly and difficult.

A forced draft system configuration means that the system operates under absolute pressure (e.g., above atmospheric pressure). The force draft configuration of the preferred plant is effectively isolated from the atmosphere, even if there are openings to the atmosphere in the fluid pathways. This means that contaminants cannot enter the system. The forced draft configuration also means that any fuel gas that enters the system is burnt in flue gas, rather than in air, which prevents nitrogen from being introduced into the system.

The forced draft system configuration in a preferred embodiment of the plant is achieved by the flue gas stream being driven around the system using one or more variable speed drive (VSD) fans 318. These fans operate by blowing the flue gas around the flue gas loop.

The flash calciner 301 preferably operates as an almost isothermal unit with a mean temperature of approximately 1200° C. and a mean material temperature of approximately 1000° C. Flue gases from the preheat furnace 305 enter at approximately 1000° C. and mix and start to burn with the natural gas and oxygen at the base of the flash calciner 301. The heat generated by combustion is absorbed by the material as the calcining reaction progresses, thus combustion and heat absorption occur concurrently and maintain a relatively constant temperature environment.

The flash calciner 301 features a vessel in the form of a hollow cylindrical tube with an internal diameter determined by the desired gas velocity. The bottom of the flash calciner 301 comprises a cone at the bottom where the preheat flue gases enter tangentially, and a similar reduction cone at the top where the flue gases and material exit tangentially. The mechanical construction of the flash calciner 301 preferably comprises an outer carbon steel shell with an internal lining of castable refractory with an insulating castable backing.

The mass ratio of feed to gases into the flash calciner 301 is preferably around 1:1, and the mass ratio of product to gases at the exit of the flash calciner 301 is preferably around 0.5:1 (since the mass of CO₂ in the feed is lost from the solids into the flue gases).

The basic design requirement for the flash calciner 301 is to ensure that the upward gas velocity is sufficiently high to ensure that the finely divided solid material is held in suspension and conveyed out of the flash calciner 301 with the exiting gas flow.

The reaction kinetics of the process determines the required residence time for the material in the hot gas stream. Thus, in simple terms, the gas flowrate determines the calciner diameter, and the residence time the calciner height.

The recycled flue gases, which are heated by the preheater furnace 305, tangentially enter the base of the flash calciner 301 at a high enough velocity to ensure that there is no material drop out into the base section of the flash calciner 301. These gases are then expanded to the design velocity in the main body of the flash calciner 301.

An example of the composition of gases that leave the preheater furnace 305 and subsequently enter the flash calciner 301 are shown in Table 1, below.

TABLE 1
Composition of preheater furnace gases that enter into the calciner.

| Component | Mass % |
|---|---|
| CO₂ | 84.94% |
| H₂O | 11.48% |
| N₂ | 0.25% |
| O₂ | 0.75% |
| Ar | 2.57% |
| Total | 100.00% |

During the calcination process, fuel such as natural gas may be injected radially into the flash calciner 301 near to the base of the main calciner section, through a ring of equi-spaced nozzles. A similar arrangement around the conical expansion section allows for the oxygen nozzles.

Natural gas or another fuel is burnt in the presence of oxygen in the flash calciner 301 to provide the energy required for the endothermic calcination process. The preheater furnace 305 is preferably designed as a natural gas fired, down-fired combustor, which uses recycled flue gases in lieu of atmospheric nitrogen to provide the inert gas component for oxy-fuel firing. The oxygen required is delivered from the oxygen plant 311 under normal operation, and the purity of this oxygen affects the final flue gas CO₂ concentration.

Table 2 indicates exemplary temperatures in the flash calciner. In the flash calciner, the CaCO₃ starts to calcine at temperatures of above 500° C. Without wishing to be bound by theory, the calcination process is thought to be complete when the temperature reaches 900° C., for instance 950° C., more preferably over 950° C. At these temperatures, it is thought that the internal temperature gradients in the particles in the flash calciner have all reached at least 900° C. These temperatures also allow for the diffusion of CO₂ and other mineral impurities out of the CaCO₃ particles.

TABLE 2
example temperatures in the flash calciner.

| | | |
|---|---|---|
| Maximum (adiabatic) | 1364° | C. |
| Average | 1077° | C. |
| External wall | 103° | C. |

The flash calciner of the present invention can achieve greater than a 99%, preferably greater than 99.9% rate of calcination.

Advantageously, the flash calciner can operate at sub-stoichiometric oxygen conditions in order to reduce oxygen contamination in the flue gas produced in the flash calciner.

The calcination process that takes place in the flash calciner when the metal carbonate is calcium can be expressed as:

CaCO₃+Δ→CaO+CO₂

The standard Gibbs free energy of this reaction in [J/mol] is approximated as ΔG°ᵣ≈177,100 J/mol−158 J/(mol*K)*T. The standard free energy of reaction is 0 in this case when the temperature, T, is equal to 1121K, or 848° C.

The skilled person will appreciate that any Group 1 or Group 2 metal may be used in place of calcium.

For the avoidance of doubt, Group 1 metals are Li, Na, K, Rb, Cs, Fr. Group 2 metals are Be, Mg, Ca, Sr, Ba, Ra.

When an alternative metal carbonate is used (e.g., any Group 1 or Group 2 metal), the calcination reaction shown above will simply liberate an alternative metal oxide. If the metal of the metal carbonate is a Group 2 metal, the stoichiometries of the reaction will be the same as above for calcium carbonate.

For example, the generic reaction for a calcination process can be expressed as:

MCO₃+Δ→MO+CO₂

Typically, the metal of the metal carbonate in the calcination reaction is a Group 2 metal or a combination thereof. Often, the metal carbonate is magnesium carbonate, calcium carbonate, dolomite or combinations thereof. Most often the metal carbonate is calcium carbonate as this compound is readily available and inexpensive.

Group 2 metals are generally used, as Group 2 metal cations have a higher charge density and a greater polarising power than, for instance, Group 1 metal cations. Therefore, the C—O bond in the Group 2 carbonates is more polar covalent, meaning the bond is weaker and subsequently easier to break down.

When the metal carbonate is calcium carbonate, an exhaust stream comprising CaO and CO₂ exits the flash calciner is discharged through a coned down tangential exit duct into the cyclone separator 302.

The exhaust stream comprises both a particulate (e.g., which comprises the CaO) and a fluid (e.g., which comprises the CO₂) phase. A portion of the CaO may then be separated from the flue gas stream in a separator such as cyclone separator 303, which is preferably a high efficiency cyclone separator.

Cyclone separator 303 operates by utilising a highly swirling flow field, including interactions between the particulate and fluid phases. The cyclone separator 303 has an induced centrifugal force which is tangentially imparted on the wall of the cyclone cylinder. This force, with the density difference between the gas and solid, increases the relative settling velocity and causes the particles to move downward under the influence of gravity to the base, whilst the gas flow is channelled upwards to the top of the cyclone.

The CaO (i.e., the calcined lime) may be discharged and sequestered through an air locking system (rotary or double flap valves) in the high efficiency cyclone into a cooler 306 (such as a fluid bed cooler) to reduce the temperature of the lime close to atmospheric conditions before being stored in a holding vessel such as a product lime silo 309. Pumps/fans 310 and 308 may be used to direct a cooling air flow through the cooler 306, with an optional cooler dust filter 307 being used to clean the exiting air flow. The hot air from the cooler may optionally be used to provide air for the drying and milling system. An auxiliary in-duct, natural gas fired burner is included in this circuit to provide additional heat for feed material drying as required.

In a preferred embodiment, the cooler uses a plurality (such as three) of fluid bed stages to cool the lime to a sufficiently low temperature for conventional material handling equipment. A proportion of the hot air from a stage (preferably the first stage, where multiple stages are present) of the product cooler is fed directly to the stage four cyclone 303d where it will be used to preheat the dried, milled feed stone. A proportion of the hot air from a stage (preferably the second stage, where present) of the product cooler is fed and used in the milling system to dry and convey the milled calcitic mineral feed to the feed silo.

After the separation of the CaO, a portion of the flue gas stream can then continue through the system and move through the cyclonic heat exchangers (e.g., via the fourth stage cyclone 303d gas inlet) in a counter current manner to the CaCO₃ particulate stream.

Once the flue gas stream has moved through the cyclonic heat exchanger, a portion of the stream then enters the condensing heat exchanger 304. Water enters the condensing heat exchanger 304 from a water tank 315 and is driven into the system via a pump 316. The flue gas stream is cooled to a lower temperature, for example below 100° C., preferably from 90° C. to 98° C., in the condensing heat exchanger 304.

The skilled person will appreciate that some water vapour from the condensing heat exchanger enters the flue gas stream and is carried around the system of the invention. When the flue gas is mixed with water vapour, the extraction of carbon dioxide is simple to achieve by cooling the mixture of gases to a point at which the water vapour condenses to liquid water.

The cooled flue gas stream exits the condensing heat exchanger 304. A portion of the CO₂ in the flue gas stream may be separated from the stream and sequestered, Subsequent CO₂ compression equipment can produce high purity commercial grades of CO_{2.} Prior to the compression step, the flue gas may be dried and/or pass through a product dust filter 317.

The sequestered gases typically comprise about 96.6% purity CO2, the balance being about 2.4% argon, about 0.8% oxygen, and about 0.2% nitrogen (all % being by weight). Requirements for further gas purification will be a function of the final use of the CO₂.

In a preferred embodiment, the compression of the sequestered CO₂ is carried out using a direct steam driven turbine/compressor unit, utilising the steam generated from the cooling of the calciner gases. This will potentially reduce the electrical power requirement by ˜50%.

The flue gas from the cyclonic heat exchanger 303 contains a significant amount of low-grade waste heat, which, in a preferred embodiment, is used to raise steam to drive the turbine compressor system for the first stage of the gas compression plant (e.g., the air compressor unit). The recovery system is a single pass, coiled shell and tube heat exchanger to which the conditioned feed water passes through the tubes. The heat exchanger uses the flue gas on the shell side to raise the water to evaporation temperature and generate medium pressure superheated steam at ˜12 barg. Water (steam) in the flue gases is partially condensed, and provision is made for some condensate in the design. The flue gases leave the heat exchanger at 106° C. The steam is generated at 12 barg with a specific enthalpy of 2786 kJ/kg, giving 63 kJ/kg of superheating.

The flue gas analysis for the inlet and outlet gases are given in Table 3.

TABLE 3
Flue gas analyses for condensing heat exchanger

| | Inlet flue | Outlet flue | Outlet flue gas |
|---|---|---|---|
| Component | gas mass % | gas mass % | mass % (dry) |
| CO₂ | 83.92 | 89.78 | 96.71 |
| H₂O | 13.23 | 7.17 | 0 |
| Ar | 1.99 | 2.13 | 2.29 |
| O₂ | 0.67 | 0.72 | 0.78 |
| N₂ | 0.19 | 0.20 | 0.22 |
| Total | 100.00 | 100.00 | 100.00 |

A portion of the remaining flue gas stream then enters the furnace 305, optionally driven by a fan 318. The furnace 305 may also be referred to as a start-up or a preheater furnace.

In a preferred embodiment, the fans 318 used in the system are centrifugal, high temperature fans with variable speed drive (VSD) motor control, which controls the flow of gases around the system, and are of sufficient delivery pressure to give a positive pressure (e.g., absolute pressure) through the whole system up to the dust filter after the condensing heat exchanger.

The furnace 305 is required to perform one or more of a range of operational scenarios. These are as follows:
1. To cure any refractory material prior to initial start-up of the system.
2. To heat the system to operating temperature.
3. To provide hot gases to commission and prove the system.
4. To provide sufficient hot gases at above the calcination temperature to the base inlet of the flash calciner to maintain an adequate flow of gases through the system.

In usual operation the preferred function of the furnace 305 is predominantly to fulfil step 4 above.

The furnace 305 is preferably designed as a down-fired combustor, which uses recycled flue gases in lieu of atmospheric nitrogen to provide the inert gas component for oxy-fuel firing during normal operation. The default design is for natural gas as the fuel source, but the basic design is suitable for a range of gaseous and solid/liquid fuels by suitable modifications to the design of the burner. The above operational scenarios (1-4) are achieved by combustion of the corresponding reactants (1-4), shown below:
1. Natural gas and air
2. Natural gas and air
3. Natural gas and air
4. Natural gas, oxygen, and recycled flue gases (CO₂/H₂O)

Cases 1, 2 and 3 are transient operations, lasting only a few days, whilst case 4 is the primary mode of operation for the furnace for sustained periods.

Case 4 is most operationally demanding mode, since it requires both a thermal load, flue gas composition and flowrate that is matched to the flash calciner requirements, and the design parameters are based on the process requirements of the inlet gas flow and temperature to the flash calciner. This requires a high level of design integration for the process control logic to enable the load changes and perturbations to be managed safely between the two furnaces, and within the total process demand limits.

In a preferred embodiment of the present invention, the design of the furnace is based on a firing density of 0.6 MW/m³ of internal furnace volume. The skilled person is able to choose the appropriate firing density using routine skill and knowledge.

In a preferred embodiment, the physical shape for the body of the furnace 305 is cylindrical, with the burner located axially at one end, since the aerodynamics are more predictable.

As described above, the calcitic mineral feed is preferably dried and/or finely ground in a milling system such as that shown in FIG. 5 prior to entering the series of cyclonic heat exchangers 303.

Wet calcitic mineral feed is fed into the milling system via a feed hopper 501 coupled to a calibrated feeder 502, which is in turn coupled to a mill and classifier 503. The mill and classifier 503 has an inlet for hot air to enter the system (e.g., by a duct air heater 504 that operates using fuel gas and air from the product cooler), an outlet for mill rejects, and outlets for air and dry milled stone.

The mill of FIG. 5 generally corresponds to the milling system 312.

The feed hopper 501 generally corresponds to the feed hopper 313.

The mill component 503 of the milling system may comprise ball or tube mills, roller mills and/or impact mills.

The function of the milling system is to reduce the wet calcite material from a pre-crushed raw stone size of typically 5-10 mm to a dry, free flowing powder, with an area mean average diameter of ˜60 μm.

The calcite material feedstock can be in any naturally occurring form of limestone, including limestone, magnesite, chalk, dolomite, coral sand, oil shales, coal with a high carbonate content and seashells.

In a preferred embodiment, the feed material is ground chalk with included flint. The typical analysis is given in table 4.

TABLE 4
Typical feed chalk analysis

| Component | SiO₂ | Al₂O₃ | Fe₂O₃ | CaCO₃ | MgCO₃ | Total | wet basis H₂O |
|---|---|---|---|---|---|---|---|
| Mass % | 2.9 | 0.3 | 0.29 | 96.31 | 0.2 | 100 | 10.0 |

The impurities that can be found in calcitic mineral (limestone) sources include CaO, MgO, CO₂, SiO₂, Al₂O₃, Fe₂O₃, SO₃, P₂O₅, Na₂O, K₂O, H₂O and other trace elements. Trace elements that may be found in naturally occurring forms of limestone include copper, manganese and titanium as oxides, sometimes together with other elements such as chlorine, fluorine, arsenic, strontium, cobalt, zinc, boron, niobium, molybdenum, vanadium, chromium, strontium, barium, mercury and lead. Some organic matter, which may be carboniferous, may also be present as the result of naturally decayed organic material as well as deposited residues such as soot, VOCs, dioxins and furans derived from anthropogenic sources.

The calcitic mineral feed is preferably ground to a particle size of 5 to 120 μm. Further separation of the particles is then carried out, e.g., by sieving or air systems in order to achieve particles with a particle size of from preferably 40 to 100 μm, more preferably of 60 to 80 μm. Without wishing to be bound by theory, the inventors have found that these particle sizes ensure that the resulting calcitic mineral particulate has the correct residence time in order to move through the system effectively.

The particle size is a measure of the particle diameter across its largest dimension.

Preferably, the calcitic mineral particles has a residence time of 1 to 5 seconds, preferably 3 to 5 seconds, more preferably 3 seconds in the flash calciner.

The calcitic mineral particulate is then fed into the top of a series of a cyclonic heat exchanger or series of cyclonic heat exchangers and is preheated by the counter current flow of flue gases from the flash calciner. The calcitic mineral particulate stream is preferably heated to a temperature of above 500° C., more preferably between 600° C. to 700° C., even more preferably 650° C. to 750° C.

A benefit of the calcitic mineral being heated in this matter is that it allows for a more efficient calcination process. CaCO₃ has a calcination point of above 500° C. This means that when the calcitic mineral particulate exits the series of cyclonic heat exchangers and enters the flash calciner, the material is starting to calcine. Therefore, the present invention represents an energy efficient process wherein the heat generated by the reaction carried out in the flash calciner is captured and utilised in a differed stage of the process.

The skilled person will appreciate that any of the range values discussed above can be scaled in accordance with the size of the plant.

FIG. 4 shows an exemplary cyclone suitable for use in a cyclonic heat exchanger. As described above, the cyclone features an inlet 401 for receiving feed material and hot flue gas, an outlet 403 coupled to a flash calciner for delivering pre-heated feed material to the flash calciner, and an outlet 402 coupled to an inlet valve of a condensing heat exchanger.

With reference to FIG. 4, the dimension ratios of cyclones that may be used in the present invention are as follows:

TABLE 5
Dimensional ratios for various cyclone designs

| | | | High | High |
|---|---|---|---|---|
| | Short | Stairmand | efficiency | loading |
| b= | 0.24 D | 0.25 D | 0.20 D | 0.375 D |
| Dₑ= | 0.43 D | 0.50 D | 0.50 D | 0.75 D |
| a= | 0.34 D | 0.50 D | 0.50 D | 0.75 D |
| h= | 0.60 D | 2.00 D | 1.50 D | 1.50 D |
| S= | 0.57 D | 0.625 D | 0.50 D | 0.875 D |
| H= | 2.00 D | 4.00 D | 4.00 D | 4.00 D |
| B= | 0.35 D | 0.25 D | 0.375 D | 0.375 D |

Mass and energy balances for the calciner system are shown in Tables 6 and 7 respectively and are the basis for a design for an example production plant. The mass balances are fully resolved for all the process units, and the small iteration error (0.6 kW) on the energy balance is well within acceptable tolerances for the design process. All energy balances are relative to a datum temperature of 0° C.

TABLE 6
Calciner system mass balance for 50000TPA CO₂ plant

| Input | | | Output | | |
|---|---|---|---|---|---|
| Feed stone | 3.044 | kg/s | Calcined product | 1.514 | kg/s |
| Steam feed | 0.657 | kg/s | Flue gas (CO₂/N₂/ | 1.413 | kg/s |
| water | | | O₂/ H₂O/Ar) | | |
| Natural gas | 0.163 | kg/s | Steam (net export) | 0.657 | kg/s |
| Oxygen | 0.695 | kg/s | Process air (ex-mill) | 5.482 | kg/s |
| Process air | 5.176 | kg/s | feed stone + dust | 0.459 | kg/s |
| (cooler) | | | | | |
| Second stage | 6.716 | kg/s | Second stage | 6.716 | kg/s |
| cooling air | | | cooling air | | |
| Third stage | 6.716 | kg/s | Third stage | 6.716 | kg/s |
| cooling air | | | cooling air | | |
| | | | Condensate | 0.211 | kg/s |
| | | | Unaccounted | 0.00 | kg/s |
| Total | 22.167 | kg/s | Total | 22.167 | kg/s |

TABLE 7
Calciner system energy balance for
50000TPA CO₂ plant (datum 0° C.)

| Input | | | Output | | |
|---|---|---|---|---|---|
| Feed stone | 63.1 | kW | Calcined product | 67.2 | kW |
| Natural gas | 7.6 | kW | Flue gas (CO₂/N₂/ | 426.1 | kW |
| (sensible) | | | O₂/H₂O/Ar) | | |
| Natural gas | 8711.6 | kW | Condensate water | 54.1 | kW |
| (combustion) | | | | | |
| Oxygen | 14.3 | kW | Calcination | 4335.6 | kW |
| | | | reaction energy | | |
| Feed water | 41.3 | kW | Feed stone + dust | 200.0 | kW |
| (sensible) | | | | | |
| CO₂ Compressor | 376.4 | kW | Heat loss | 482.9 | kW |
| power | | | | | |
| Process air | 87.8 | kW | Mill exhaust air | 389.3 | kW |
| (cooling + | | | | | |
| milling) | | | | | |
| Second stage | 114.0 | kW | Second stage | 499.2 | kW |
| cooling air | | | cooling | | |
| Third stage | 114.9 | kW | Third stage | 243.0 | kW |
| cooling air | | | cooling air | | |
| Electrical | 321.3 | kW | Stone drying | 687.4 | kW |
| power(calciner) | | | (latent heat) | | |
| PSA power | 969.3 | kW | Absorbed | 1667.0 | kW |
| | | | electrical power | | |
| | | | Steam (exported) | 1770.4 | kW |
| | | | Unaccounted | −0.6 | kW |
| Total | 10821.6 | kW | Total | 10821.6 | kW |

1. A process for producing metal oxide in a flash calciner, the process comprising:
a. pre-heating a metal carbonate particulate stream, prior to the particulate stream being fed into the flash calciner; and,
b. calcining the particulate stream in a flash calciner to produce a raw stream comprising metal oxide and a flue gas comprising CO₂,
wherein at least a portion of the flue gas comprising CO₂ produced in step (b) is used to pre-heat the metal carbonate particulate in step (a); and
wherein at least a portion of the flue gas comprising CO₂ produced in step (b) is recycled back into the flash calciner via a furnace.

2. A process according to claim 1, wherein step (a) is carried out by feeding the particulate stream and a portion of the flue gas stream comprising CO₂ into a cyclonic heat exchanger system in a counter flow arrangement.

3. A process according to claim 2, wherein the cyclonic heat exchanger system comprises a plurality of series connected cyclonic heat exchangers, preferably at least four cyclonic heat exchangers.

4. A process according to claim 1, comprising a step of separating a portion of the raw stream, after it exits the flash calciner, into a metal oxide stream and a flue gas stream which comprises CO₂.

5. A process according to claim 4, wherein the separation of the portion of the raw stream is carried out by a cyclone separator.

6. A process according to claim 1, wherein the furnace heats the flue gas comprising CO₂ to a temperature capable of maintaining auto-ignition of a fuel within the flash calciner.

7. A process according to claim 1, wherein the furnace heats the recycled flue gas stream to a temperature of from 500° C. to 1200° C., preferably from at least 650° C. to 1200° C., more preferably 900° C. to 1100° C.

8. A process according to claim 4, comprising a step of feeding a portion of the metal oxide from the separator to a cooler.

9. A process according to claim 8, wherein the cooler is controlled to exclude CO₂.

10. A process according to claim 1, comprising a step of feeding an admixture of fuel and oxidant into the flash calciner.

11. A process according to claim 1, comprising a step of feeding an admixture of fuel and oxidant into the furnace.

12. A process according to claim 10, wherein the fuel comprises a gaseous hydrocarbon and the oxidant comprises oxygen/oxygen enriched air.

13. A process according to claim 12, wherein the oxygen enriched air comprises at least 50% by weight oxygen.

14. A process according to claim 1, wherein a portion of the flue gas is driven using a fan to the flash calciner.

15. A process according to claim 1, wherein a portion of the flue gas stream comprising CO₂ passes through a condensing heat exchanger, wherein this step occurs after the portion of the flue gas stream is used to pre-heat the metal carbonate particulate stream.

16. A process according to claim 15, comprising a step of separating and sequestering a portion of the CO₂ in the flue gas stream that has passed through the condensing heat exchanger.

17. A process according to claim 1, wherein the metal carbonate particulate stream comprises CaCO₃ particles with an average particle size of 5 to 120 μm.

18. A process for calcining a metal carbonate feedstock within a flash calciner to produce a metal oxide and flue gas comprising CO₂, wherein the process comprises recirculating a least a portion of the CO₂ flue gas at a pressure above atmospheric pressure within a closed loop fluid path which includes the flash calciner.

19. A process according to claim 18, wherein the CO₂ flue gas is recirculated at above atmospheric pressure within the fluid path using a fan.

20. A process according to claim 18, wherein the CO₂ flue gas is heated within a preheater furnace by combustion of a fuel/oxygen mixture to a temperature of 500° C. to 1200° C., preferably from at least 650° C. to 1200° C., more preferably 900° C. to 1100° C.

21. A process for calcining a metal carbonate feedstock within a flash calciner to produce a raw stream comprising metal oxide and a flue gas comprising CO₂, wherein the process comprises recirculating and feeding a portion of the flue gas comprising CO₂ back into the flash calciner via a fluid path which includes a preheater furnace which heats the flue gas comprising CO₂ to a temperature capable of maintaining auto-ignition of a fuel within the flash calciner.

22. A process according to claim 21, in which the temperature is at least around 650° C.

23. A process according to claim 21, wherein the CO₂ flue gas is recirculated at above atmospheric pressure within the fluid path using a fan.

24. A process according to claim 21, wherein the recirculated CO₂ flue gas is used to carry a fluidised stream of metal carbonate feedstock through one or more counter flow cyclonic heating stages, such that the metal carbonate feedstock is thereby heated by the CO₂ flue gas prior to being fed into the flash calciner.

25. A calcination plant comprising:
a flash calciner arranged to calcine a metal carbonate particulate stream;
a cyclonic heat exchanger system coupled to the flash calciner and configured to feed the metal carbonate particulate stream into the flash calciner,
wherein a flue outlet of the flash calciner is coupled to an inlet of the cyclonic heat exchanger system such that in use, at least a portion of the flue gas produced by calcination of the metal carbonate particulate stream is used to pre-heat the metal carbonate particulate in the cyclonic heat exchanger system;
wherein a flue outlet of the cyclonic heat exchanger system is coupled to a flue gas inlet of the flash calciner such that a flue gas recycle loop is formed,
and further comprising a furnace between the cyclonic heat exchanger system and the flash calciner, wherein the furnace comprises an inlet for receiving oxygen and fuel, an inlet for receiving flue gas from the cyclonic heat exchanger, and an outlet for releasing heated flue gas to the flash calciner.

26. A calcination plant according to claim 25, wherein the cyclonic heat exchanger system is configured such that, in use, the portion of the flue gas produced by calcination of the metal carbonate particulate stream moves through the cyclonic heat exchanger system in a counter current manner to the metal carbonate particulate stream.

27. A calcination plant according to claim 26, wherein the cyclonic heat exchanger system is a plurality of series connected cyclonic heat exchangers, preferably at least four cyclonic heat exchangers.

28. A calcination plant according to claim 25, wherein a separator is coupled between the flue outlet of the flash calciner and the inlet of the cyclonic heat exchanger such that in use, the flue gas stream leaving the flash calciner through the flue is separated into two streams; one stream which comprises a product for collection and a second stream which comprises flue gas.

29. A calcination plant according to claim 28, wherein the separator is a cyclone separator.

30. A calcination plant according to claim 25, further comprising a condensing heat exchanger between the cyclonic heat exchanger and the furnace, wherein the condensing heat exchanger is configured such that a portion of CO₂ from the flue gas stream can be separated and sequestered.
